(19) United States
(12) Patent Application Publication
(10) Pub. No.: US 2011/0095015 A1
(43) Pub. Date: Apr. 28, 2011

(54) Electric Pressure Cooker with a Multi-function Detachable Cooking Seat

(76) Inventor: Yao Tsung Kao, Tainan City (TW)

(21) Appl. No.: 12/605,354

(22) Filed: Oct. 25, 2009

(51) Int. Cl. H05B 3/02

(52) U.S. Cl. 219/433

(57) ABSTRACT

An improved cooker including a cooking container, and a cooking seat; the cooking container could be any kind of cooking devices like an elastic pressure pot, a kettle, etc.; the cooking seat includes a cooking control panel, a heating plate, and a pressure switch. While the elastic pressure pot includes a pot body and a pot cover. The elastic pressure pot body further includes two dual handles and a plurality of radially-extending circumferentially-spaced locking pieces. The elastic pressure pot cover includes a safety bolt, a plurality of engaging pieces, a pot cover handle, a venting valve, and a safety valve.

### FIELD OF THE INVENTION

The present invention relates to improved energy-saving electrical pressure cookers of multiple functions, and particularly to those which include within a heating plate and a pressure switch, with the flange of the heating plate further disposed with a blocking wall. A pressure cooker, a kettle or a cooking pot can be placed on the cooking seat for cooking.

### DESCRIPTION OF PRIOR ARTS

Due to the recent progress in modern civilization and high technology, products of modern civilization to facilitate a easy life can all be seen in the market. Among them, electric and electronic cookers are widely used in our daily life. The high rising price in gasoline inadvertently calls for our attention to the issue of energy saving in water, gas, electricity, etc. In general, the longer time a cooker works, the higher energy it consumes. It is therefore an essential goal of cooker manufacturers to develop energy-effective cookers.

### OBJECTS AND BRIEF SUMMARY OF THE INVENTION

An object of the present invention is to provide a pressure cooker, of which the cooking seat is adapted for different types of containers, irrespective of an elastic pressure cooker, a kettle, or any kinds of cooking device.

The present invention discloses an improved cooker including a cooking container, and a cooking seat; the cooking container could be any kinds of cooking devices like an elastic pressure pot, a kettle, etc.; the cooking seat includes a cooking control panel, a heating plate, and a pressure switch.

While the elastic pressure pot includes a pot body and a pot cover. The pot body further includes two dual handles and a plurality of radially-extending circumferentially-spaced locking pieces. The pot cover includes a safety bolt, a plurality of engaging pieces, a pot cover handle, a venting valve, and a safety valve.

Further features and advantages of the invention will be apparent from the description below.

### BRIEF DESCRIPTION OF DRAWINGS

The invention is herein described, by way of example only, with reference to the accompanying drawings, wherein:

FIG. 1 is an exploded three-dimensional view illustrating one form of pressure cooker constructed in accordance with the present invention;

FIG. 2 is an assembly view of the pressure cooker of FIG. 1;

FIG. 3 is a perspective side sectional view, illustrating the pressure cooker of FIG. 1.

FIG. 4 illustrates the locking action of the pot cover and the pressure pot of the pressure cooker constructed in accordance with the present invention;

FIG. 5 is a perspective assembly view of the pressure cooker in cooking illustrated in FIG. 1;

FIG. 6 illustrates the way a cooking device or a kettle is positioned on the heating plate for cooking.

### DETAILED DESCRIPTION OF DRAWINGS

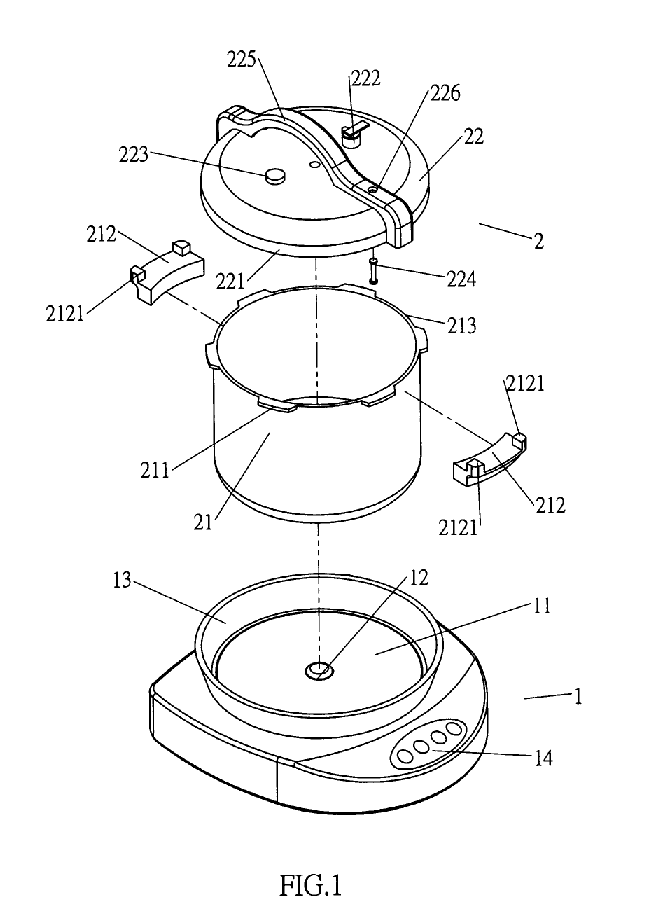

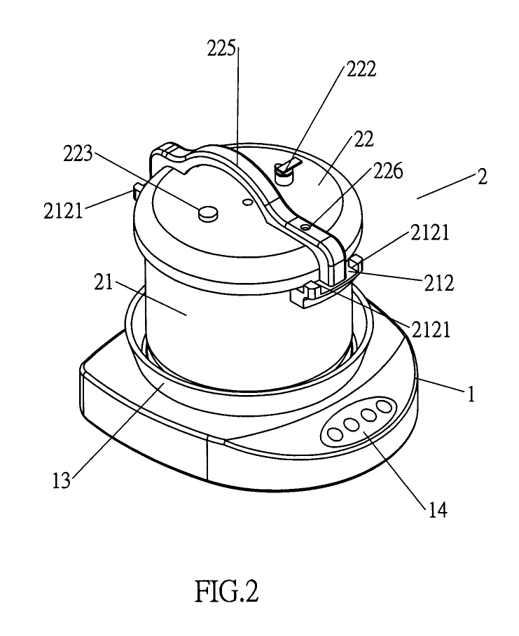

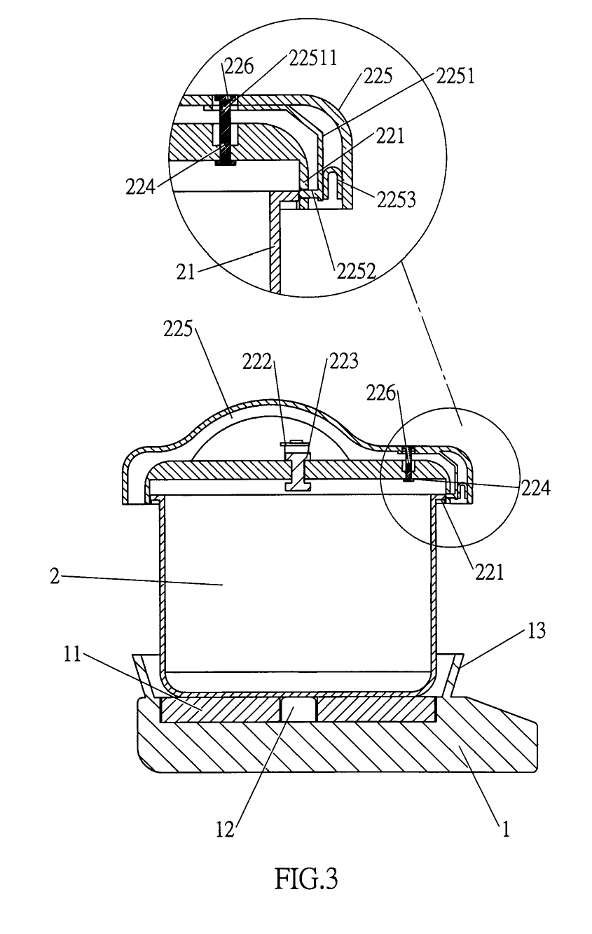

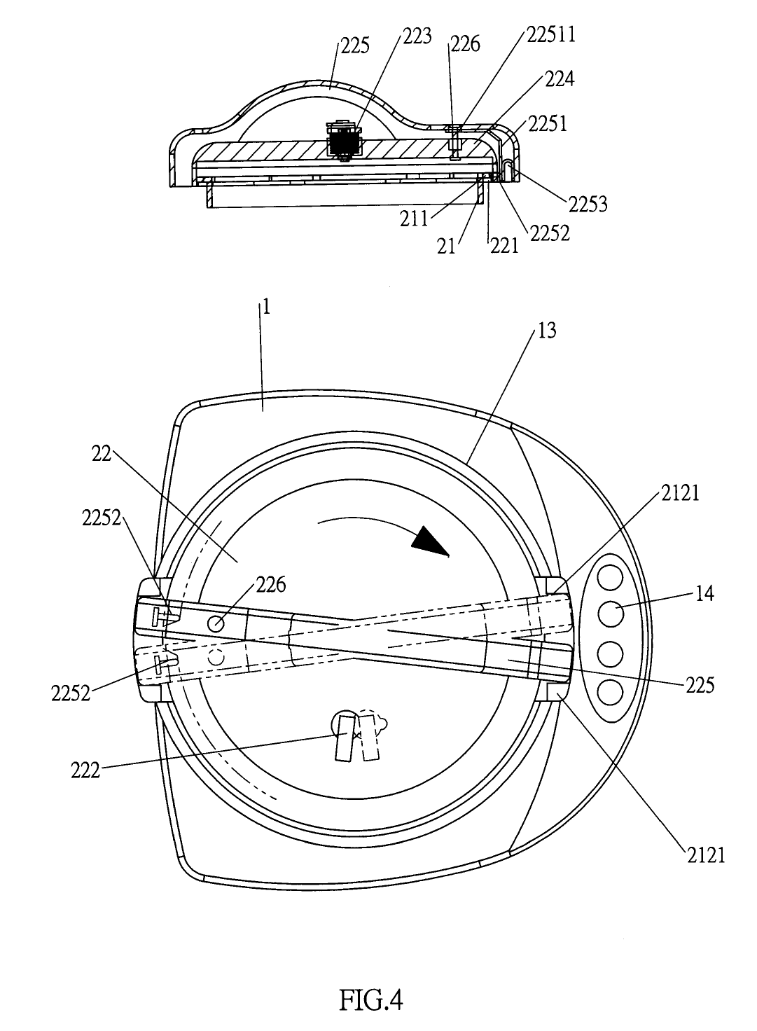

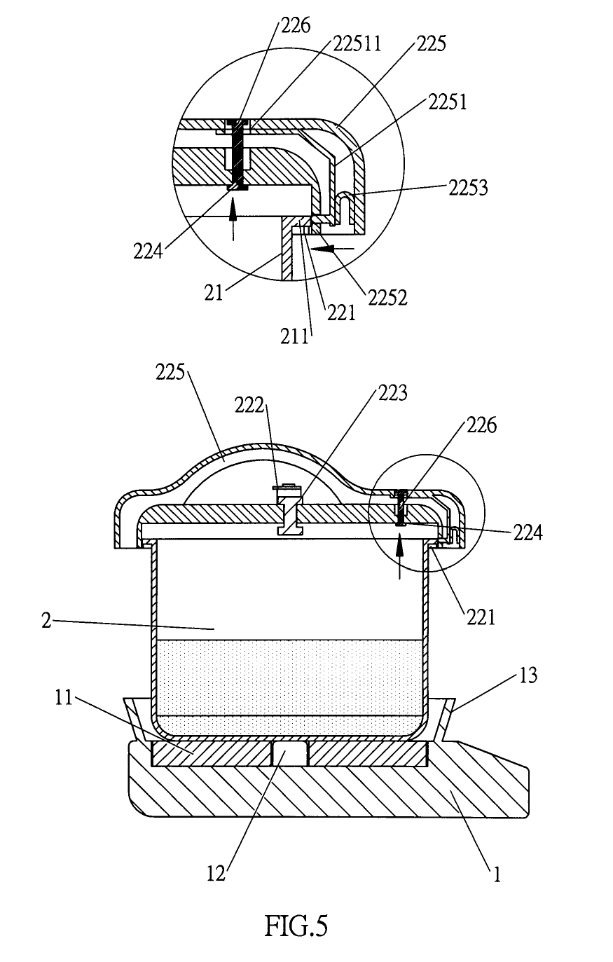

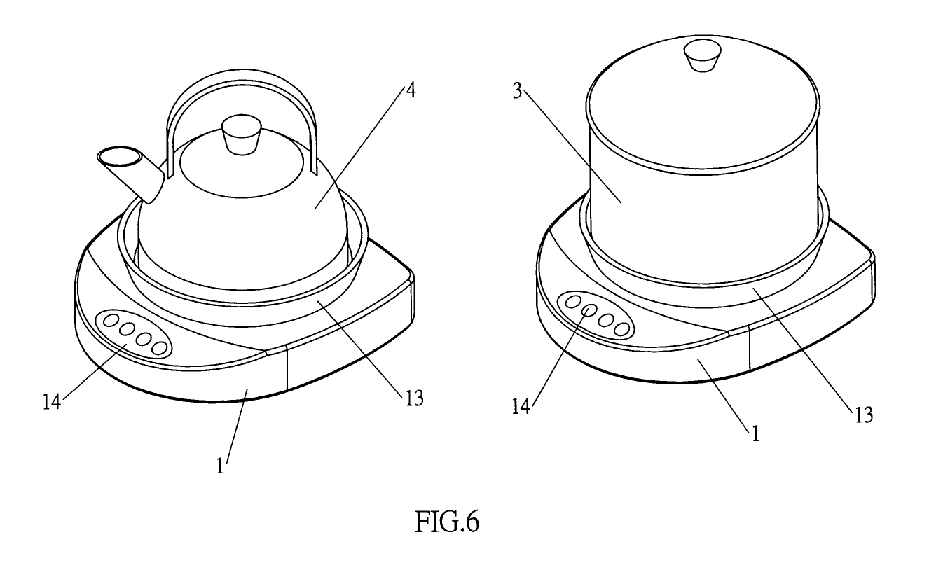

Please refer to FIGS. 1 to 6 for the present invention. A preferred embodiment of the present invention includes a cooking seat 1 of a specially designed shape such as round, square, etc. Within the cooking seat 1 is disposed a heating plate 11 and a pressure switch 12. The heating plate 11 is placed on the top of the cooker seat 1 to facilitate its contact with the bottom of the pressure pot 2. The pressure switch 12 is provided in the center of the heating plate 11, which projects (to some degrees) of the heating plate 11. A blocking wall 13 is provided around the outer flange of the heating plate 11, which extends upwards at a desired height to avoid inappropriate contact of a user's hands with the heating plate 11. A pressure pot 2, a cooking device 3, or a kettle body 4 can be placed on top of the cooker seat 1 and the pressure switch 12. Due to the downward pressure from the pressure pot 2, the cooking device 3, or the kettle body 4, the pressure switch 12 will drop down to conduct an electric current; the control panel 14 of the cooking seat 1 further controls the cooking.

The pressure pot 2 includes a pot body 21, and a pot cover 22. A plurality of radially-extending circumferentially-spaced locking pieces 211 are equidistantly arranged around the top flange of the pot body 21; in the meantime, a plurality of engaging pieces 221 are provided around the pot cover 22 to correspond to the plurality of locking pieces 211 of the pot body 21. The plurality of engaging pieces 221 inserts into the groove 213 in between the locking pieces 211. By revolving the pot cover 22, the plurality of engaging pieces 221 are locked into the bottom of the corresponding locking pieces 211, which makes pot cover 22 tightly secured in the top flange of the pot body 21.

A pot cover handle 225 with two ends, a venting valve 222, a safety valve 223 and a safety bolt 224 are provided on the pot cover 22. Air within the pot body 21 goes out from the venting valve 222. During the time when the exhale valve 222 is blocked, air can still go out by the soft safety valve 223 for safety concern. A through hole 226 is disposed at one of the pot cover handle 225. A dual handle 212 is provided on both sides of the pot body 21. An engaging block 2121 is positioned on both sides of the inner flange of the dual handle 212. The engaging block 2121 is able to engage with the end of the pot cover handle 225. A pulley piece 2251, a button 2252, and an elastic piece 2253 are provided on one side of the pot cover handle 225. An engaging hole 22511, corresponding to the safety bolt 224 of the pot cover 22, is further positioned on the sliding piece 2251. The button 2252 projects out of the outer flange of the pot cover 22 and correspond to the locking pieces 211 on top of the pot body 21. At the rear of the button 2252 is provided an elastic piece 2253, which helps the button 2252 to move back to the default starting position after displacement

When in cooking, the safety bolt 114 rises up to go into the through hole 226 and the engaging hole 22511 (of the sliding piece 2251 of the pot cover handle 225) to save the trouble of opening the pot cover 22 during cooking.

Furthermore, a cooking device 3 or a kettle 4 can also be positioned on the heating plate 11 for cooking, making the heating plate a multi-functional device to save energy.

I claim:

1. An improved electric pressure cooker, including
a cooking container, and
a cooking seat, including
a cooking control panel;
a heating plate, which includes a blocking wall around the outer flange thereof for safety concern, and is placed on said cooking seat to facilitate contact with the bottom of said pressure pot; and
a pressure switch, projected in the center of said heating plate with a blocking wall around the outer flange thereof to avoid direct contact of a user's hands with said heating plate during cooking, which drops down to conduct an electric current for cooking;

2. An improved electric pressure cooker as claimed in claim 1, wherein said cooking container is
a pressure pot, including
a pot body, includes
two dual handles, provided on both sides of said pot body, including an engaging block on both sides of the inner flange thereof, and
a plurality of radially-extending circumferentially-spaced locking pieces, equidistantly arranged around the top flange of said pot body, with a groove provided in between two of said locking pieces for engaging;
a pot cover, includes
a safety bolt,
a plurality of engaging pieces around said pot cover corresponding to said plurality of locking pieces of said pot body to secure said pot cover on top of said pot body;
a pot cover handle with two ends, a through hole, a sliding piece including an engaging hole corresponding to said safety bolt , and a button projecting out of the outer flange of said pot cover and corresponding to said locking pieces of said pot body, wherein said button further includes an elastic piece which helps said button to be positioned back after displacement;
a venting valve for air within said pot body to go out; and
a safety valve as an auxiliary air venting exit when said venting valve is blocked.

3. An improved electric pressure cooker as claimed in claim 1, wherein said cooking container is a cooking device or a kettle.
